(19) United States
(12) Patent Application Publication
(10) Pub. No.: US 2015/0007927 A1
(43) Pub. Date: Jan. 8, 2015

(54) POLYACETYLENE NANOFIBER TEMPERATURE SENSOR

(71) Applicant: SNU R&DB Foundation, Seoul (KR)

(72) Inventors: Yung Woo PARK, Seoul (KR); A Jeong Choi, Seoul (KR)

(21) Appl. No.: 14/325,447

(22) Filed: Jul. 8, 2014

(30) Foreign Application Priority Data
Jul. 8, 2013 (KR) 10-2013-0079436

(51) Int. Cl. G01K 1/16; D01F 6/28

(52) U.S. Cl. CPC G01K 1/16; D01F 6/28
USPC 156/167; 252/500; 526/285

(57) ABSTRACT

Disclosed is a polyacetylene nanofiber temperature sensor. The temperature sensor accurately senses a temperature under high magnetic fields and includes a temperature sensing unit including a polyacetylene nanofiber array in which the polyacetylene nanofibers are substantially arranged in parallel. The temperature sensing unit includes polyacetylene nanofiber networks, polyacetylene single fibers, or helical polyacetylene single fibers. The polyacetylene nanofiber is doped with iodine.

### CROSS-REFERENCE TO RELATED APPLICATION

This application claims priority to and the benefit of Korean Patent Application No. 2013-79436 filed on Jul. 8, 2013, the disclosure of which is incorporated herein by reference in its entirety.

### BACKGROUND

The present invention relates to a polyacetylene nanofiber temperature sensor, and specifically, to a temperature sensor using polyacetylene nanofibers having a vanishing magneto resistance phenomenon.

Since electrical characteristics of general materials or electronic elements are changed according to a temperature, they may be used as temperature sensors. Depending on detecting temperature ranges, detection accuracy, temperature characteristics, mass productivity, reliability, and the like, materials or elements adequate for usage purposes are used as temperature sensors. Thermocouples, temperature measuring resistors, thermistors (NTCs), and metal thermometers are used for industrial instrumentation. Also, as sensors of daily necessity devices, thermistors (NTC, PTC, and CTR), temperature sensitive ferrite, and metal thermometers are widely used. Sensors using a nuclear quadrupole resonator (NQR), ultrasound, and an optical fiber are used for special purposes. A gas thermometer, an enclosed-scale mercury-in glass thermometer, a crystal thermometer, a platinum resistance thermometer, and a platinum-platinum rhodium thermocouple are used as a reference of a temperature.

Although several materials are being used as temperature sensors, errors occur due to magneto resistance of materials resulting from a change in a magnetic field under high magnetic fields. Therefore, the development of an accurate temperature sensor that can be used under high magnetic fields is necessary.

Meanwhile, (semi)conductor PEDOT, PPV and polypyrrole nanotubes, nanowires, and double-walled nanotubes are fabricated using Al₂O₃ nanoporous templates through electrochemical polymerization or chemical vapor deposition. When each I-V characteristic curve of PPy-TBAPF6 and PEDOT-DBSA nanowires (diameters: to 200 nm) is measured, it can be seen that a current decreases as a temperature decreases according to semiconductor characteristics.

When conductivity and magneto resistance on pellets of conducting polyanilin and polypyrrole nanotubes/wires are measured, it can be seen that a transition from small negative magneto resistance to large positive magneto resistance was observed below 60 K in polyanilin and polypyrrole nanotube/wire pellets. Magneto resistance of single polymer nanotubes/wires is very small at 2 K (MR<5% at 10 T) compared to that of pellets (40 to 100% at 10 T). However, since magneto resistance is not 0, it is difficult to accurately detect under high magnetic fields when it is used in temperature sensors.

In the temperature sensor, as described above, when a magnetic field of 10 T or more is applied by a magnetic field, magneto resistance of the temperature sensor increases. That is, since a magnitude of an applied magnetic field is proportional to resistivity of a sensor, it is unable to provide a temperature sensor that can accurately measure a temperature under a high magnetic field environment such as a magnetically levitated train.

Patent Document

(Patent Document 1) Korean Unexamined Patent Application Publication No. 10-2004-0077342 (Published on Sep. 4, 2004)

Non-Patent Document

(Non-patent Document 1) J. Steinmetz, H. J. Lee, S. Kwon, D. S. Lee, C. Goze-bac, E. Abou-Hamad, H. Kim and Y. W. Park, “Routes to the synthesis of carbon nanotube-polyacetylene composites by Ziegler-Natta polymerization of acetylene inside carbon nanotubes”, Curr. Appl. Phys. 7, 39-41 (Published on July 2007)

(Non-patent Document 2) Yung Woo Park, “Magneto resistance of polyacetylene nanofibers”, Chem. Soc. Rev. 39, 2428-2438 (Published on Jun. 1, 2010)

### SUMMARY OF THE INVENTION

In view of the above-described problems in the related art, the present invention provides a temperature sensor capable of accurately detecting a temperature even under high magnetic fields.

According to an aspect of the present invention, there is provided a temperature sensor using polyacetylene nanofibers.

The temperature sensor may include a temperature sensing unit including a polyacetylene nanofiber array in which the polyacetylene nanofibers are substantially arranged in parallel.

The temperature sensing unit may preferably include polyacetylene nanofiber networks, polyacetylene single fibers, or helical polyacetylene single fibers.

The temperature sensing unit may be fabricated by a method of fabricating a temperature sensing array. The method includes extracting polyacetylene nanofibers from a polyacetylene ribbon or sheet; and

cutting the polyacetylene nanofibers to a set length, and arranging the nanofibers substantially in parallel.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows graphs of magneto resistance (MR) [(R(H)—R(0))/R(0)] on nanofibers of three different polyacetylene samples ((a) polyacetylene-1, (b) polyacetylene-2, and (c) polyacetylene-3) under high electromagnetic fields at T=1.5 K;

FIG. 2 is a graph showing a relation between magneto resistance of the polyacetylene samples and an electric field; and

FIG. 3 shows graphs of a relation between magneto resistance (MR) of the polyaniline samples and a magnetic field.

### DETAILED DESCRIPTION OF EXEMPLARY EMBODIMENTS

Hereinafter, various embodiments of the present invention will be described in greater detail with reference to the accompanying drawings. However, embodiments of the present invention may be modified in several different forms, and the scope of the present invention is not limited to the embodiments to be described below. The embodiments of the present invention are provided to fully explain the invention for those skilled in the art.

The present invention relates to a temperature sensor using polyacetylene nanofibers, and particularly, a temperature sensing unit of the temperature sensor made of an array in which polyacetylene nanofibers are substantially arranged in parallel. The polyacetylene nanofibers preferably have a quasi one-dimensional morphology. In addition, the temperature sensing unit may use polyacetylene nanofiber networks, polyacetylene single fibers, or helical polyacetylene single fibers.

Hereinafter, a method of fabricating polyacetylene nanofibers and characteristics thereof, and a temperature sensor using the same will be described.

### Polyacetylene Nanofiber Network

A method of fabricating a polyacetylene nanofiber network is as follows. First, a polyacetylene fiber network sample is prepared from synthesized low-density foam-like polyacetylene. A diameter of each nanofiber is preferably about 60 to 80 nm. A low density foam-like polyacetylene gel is cut into small pieces, put into toluene, and is diffused by ultrasonication for several seconds. After the ultrasonication, the toluene solution is centrifuged. Here, toluene used as a solvent may be replaced with propanol for better dispersion. The ultrasonication and a replacement process with propanol are repeated several times. Then, a liquid droplet of an appropriate concentration is dropped on a SiO₂ substrate under an argon flowing atmosphere and the polyacetylene nanofiber network is fabricated.

In the embodiment, a measurement result of magneto resistance of the polyacetylene nanofiber networks fabricated by the above method is as follows. First, when an average thickness of a nanofiber sample measured by AFM is 100 nm and a diameter of each fiber is 60 to 80 nm, the polyacetylene fiber network is formed smaller than a two-polyacetylene fiber layer on average. When a distance between two voltage contacts is set to about 3 um, about 25 interfibrillar junctions are in each network. Therefore, the total number of interfibrillar junctions between voltage probes is about 50 in average.

The polyacetylene nanofiber network is preferably doped by exposing to an iodine vapor in a sealed tube. When four-probe conductivity and magneto resistance (MR) of the iodine-doped polyacetylene fiber networks are measured at the micron-scale, it may be seen that temperature dependence of resistivity more significantly decreases than that of a bulk polyacetylene film. Magneto resistance at a temperature T=1.5 K is a negative value, and its relative magnitude is about 0.1% at H=10 T. This is about 1/40 of a magneto resistance signal of the bulk polyacetylene film. This result shows the importance of contact barriers in nanosize polyacetylene fiber networks. An interfibrillar contact barrier may be regarded as a naturally grown nanojunction between two metal fibers of a nanosize. It may be seen that the microsize polyacetylene fiber networks show negative magneto resistance at a temperature T=1.5 K lower than that of the bulk polyacetylene film and temperature dependence of resistivity becomes remarkably weaker than the bulk polyacetylene film.

A linear ohmic I-V characteristic is observed even in single polyacetylene nanofibers. Linear ohmic I-V dependence in high electric fields may be understood as due to soliton tunneling conduction in the polyacetylene nanofibers. In the single polyacetylene nanofiber, when a low temperature I-V characteristic of the single polyacetylene nanofiber is measured in a magnetic field up to H=6 T at a temperature T=10 K or less, it may be observed that the low temperature I-V characteristic has no change while the magnetic field is changed from 0 T to 6 T. That is, the single polyacetylene nanofiber has a zero magneto resistance characteristic. In order to determine whether the single polyacetylene nanofiber may be applied to high magnetic fields, when the applied magnetic field is up to 30 T, it may be understood that obvious vanishing magneto resistance (VMR) actually occurs in the polyacetylene nanofiber.

### Helical Polyacetylene Nanofiber

Meanwhile, in helical polyacetylene, the helical polyacetylene may use a polycrystalline structure having either an R-type (counter clockwise) or an S-type (clockwise) helicity. The single polyacetylene nanofiber is extracted from a helical polyacetylene film using a method in which hexamethylene glycol mono-n-dodecyl ether (C₁₂E₆) is used as a surfactant in an n, n-dimethylformamide organic solution. Well dispersed single polyacetylene nanofibers may have a characteristic cross section of 40 to 60 nm (vertical) and 100 to 300 nm (horizontal). A typical length of the single polyacetylene nanofiber is 10 um, which is much longer than that of a conventional polyacetylene nanofiber. In the helical polyacetylene single fiber, a long length and a highly ordered morphology are great advantages in studying transport properties.

Entanglement-free fibrils of aligned polyacetylene films may separate single fibers from newly synthesized entanglement-free fibrils of polyacetylene films without a surfactant.

### Vanishing Magneto Resistance (VMR) in High Electric Field

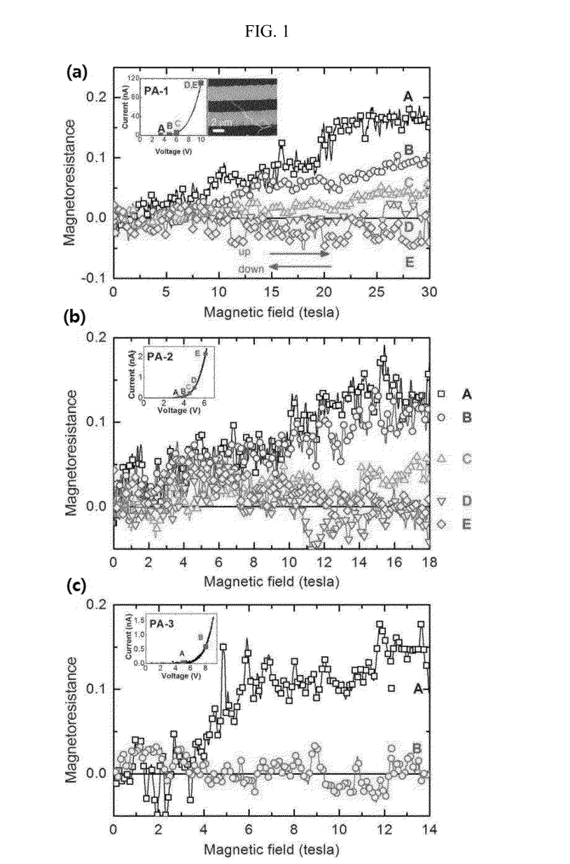

Next, a measurement result of magneto resistance of three different samples of helical polyacetylene nanofibers will be described. Three helical polyacetylene nanofiber samples (polyacetylene-1, polyacetylene-2, and polyacetylene-3) may be individually dispersed from an h-Polyacetylene film. The three dispersed nanofibers are mounted and loaded on patterned platinum electrodes, and separately doped with iodine. A magnitude of conductivity at room temperature is typically 0.1 to 1 Scm⁻¹ (doping concentration is about 1 to 2 wt %). In three separate polyacetylene nanofiber samples, symmetric I-V characteristics of a forward and reverse bias voltage are observed. It may be seen that, since Schottky barriers of both contacts are unable to be the same, a Schottky barrier formed on any of two probes does not influence sample resistivity. Magneto resistance was measured using an 18 T superconducting magnet or a 30 T resistive magnet. When magneto resistance having no orientation is observed for the sample rotated parallel and perpendicular to the magnetic field within measurement accuracy, Lorentz force-driven orbital motion deflecting charge carriers from a current flow direction is prohibited in the quasi one-dimensional polyacetylene nanofiber. As a result, it may be understood that inherent spins of the charge carriers are coupled with an external magnetic field (μₛHₑₓₜ) causing observed magneto resistance. FIG. 1 shows the results. FIG. 1 shows magneto resistance (MR) [(R(H)—R(0))/R(0)] of nanofibers of three different polyacetylene samples ((a) polyacetylene-1, (b) polyacetylene-2, and (c) polyacetylene-3) in high electromagnetic fields at a temperature T=1.5 K. Magneto resistance data has much noise immediately after a magnetic field is turned on and the noise continues. However, a peak position of the noise is changed several times according to a change in a sweeping direction of the magnetic field. Therefore, the noise in the magneto resistance data is caused by a unique reaction of the magnetic field such as a Shubnikov de Haas oscillation. Such noise in the magneto resistance does not occur in a similar polyacetylene film having high resistivity. Therefore, it may be related to a quasi one-dimensional morphology of the polyacetylene nanofiber. Aside from the noise characteristics in the magneto resistance data, when reacting of an average magneto resistance signal with an applied magnetic field is focused, initially, up to 16% magneto resistance of the polyacetylene nanofiber in a magnetic field H=30 T at a temperature T=1.5 K vanishes as the applied electric field increases in polyacetylene-1 shown in FIG. 1(a). At an average electric field of 50000 Vcm⁻¹, magneto resistance essentially disappears. FIG. 1(b) shows magneto resistance of polyacetylene-2 in different electric fields and magnetic fields up to H=18 T at a temperature T=1.5K. In FIG. 1(b), data shown in FIG. 1(a) may be confirmed by clarifying VMR in high electric fields. As shown in FIG. 1(b), zero magneto resistance is reached at 0.3 nA. Zero magneto resistance is maintained in polyacetylene-2 when a current is further increased to 2 nA. FIG. 1(c) shows magneto resistance data of another polyacetylene nanofiber (polyacetylene-3) measured up to a magnetic field H=14 T. Also, VMR may be confirmed at a sub nano ampere (to 620 pA) current level (corresponding electric field is about 4.0×10⁴ V cm⁻¹) in the polyacetylene nanofiber.

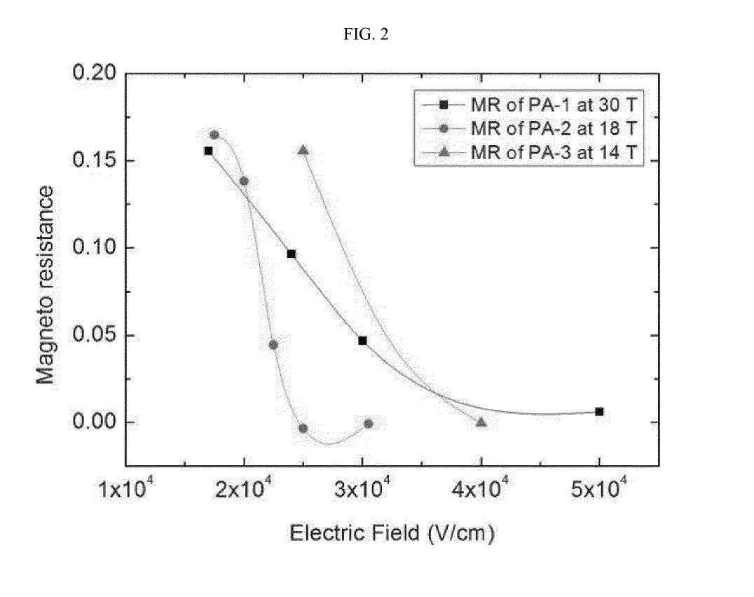

In addition, magneto resistance of a temperature of polyacetylene-1 at a current level (a corresponding electric field is about 1.7×10⁴ V cm⁻¹) of about 130 pA is as follows. In the polyacetylene nanofiber, no negative magneto resistance originating from weak localization is expected as was observed in the films of highly conducting polyacetylene film. The spins become predominantly polarized when Zeeman splitting exceeds thermal energy, that is, a few telsa (T) for T˜1.5 K, here indeed magneto resistance starts (for a low E). The starting magnetic field of magneto resistance becomes higher than an increase in the temperate. As shown in FIG. 2, about 16% of magneto resistance is observed in low electric fields at 1.5 K and 30 T. As the temperature increases from T=1.5 to 20 K, a magneto resistance signal decreases. Since energy of a 1 T magnetic field is almost the same as thermal energy of 1 K, magneto resistance vanishing at about 20 K may be understood to be caused by thermal equilibrium.

VMR of the three different polyacetylene samples shown in FIG. 2 is summarized as a function of an applied electric field. In polyacetylene-1, magneto resistance initially decreases at E>2×10⁻⁴Vcm⁻¹ and becomes zero at E>5×10-4 Vcm⁻¹. In polyacetylene-2, suppression of magneto resistance reaches zero at E≈2.5×10⁴ Vcm⁻¹ more quickly. In polyacetylene-3, magneto resistance initially decreases at E≈2.5×10⁴ Vcm⁻¹ and becomes zero at E≈4×10⁴ Vcm⁻¹. In all of the three samples, suppression of magneto resistance is shown according to a decrease of the electric field at E>2×10⁻⁴ Vcm⁻¹. When zero magneto resistance is reached once, there is no further change to negative. As shown in magneto resistance of polyacetylene-2, zero magneto resistance is maintained.

### Comparative Example

Magneto Resistance of Polyaniline (PAni) Nanofiber Doped with 1 Mol of HCl

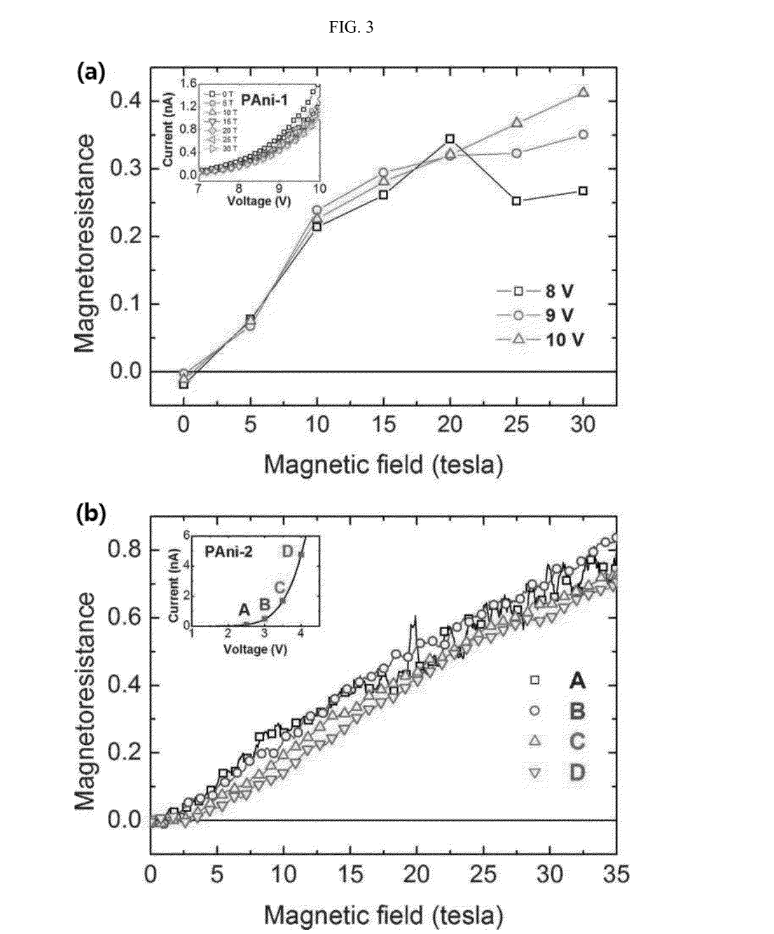

It is known that polyaniline has a non-degenerative ground state across a kink defect and a benzene structure has lower energy than a quinoid structure. Therefore, HCl doped polyaniline (an emerald base to which protons are applied) forms a polymerization (semi-quinoid radical cation) causing a polaron conduction band including polaron separation due to Coulomb repulsion. Radical cations, that is, polarons carry charges and spins. FIG. 3 shows a result of magneto resistance of the polyaniline nanofiber. Typical conductivity at room temperature is 2×10⁻⁴ Scm⁻¹. In a sample polyaniline-1, the I-V characteristic is measured in different magnetic fields up to 30 T at a temperature of 1.5 K and is plotted as a function of a magnetic field as shown in FIG. 3(a). It is apparent that the magneto resistance does not decrease as an electric field increases from 8 to 10 V. An inserted diagram in FIG. 3(a) shows the I-V characteristic in high electric fields. In given magnetic fields, a current is not merged with a current of a zero magnetic field when the electric field decreases. This means that magneto resistance of polyaniline-1 does not become zero in high electric fields and a behavior of polyaniline is more conventional and is completely different from that of polyacetylene that is independent of the electric field. As the magnetic field increases to 30 T, the value magneto resistance of polyaniline accordingly increases by 40%. It is confirmed that magneto resistance does not decrease to 35 T in high electric fields in another polyaniline nanofiber sample (polyaniline-2) as shown in FIG. 3(b).

That is, from a magneto resistance difference between polyaniline and polyacetylene nanofibers according to the electric field, which are measured in the same high magnetic field system, it may be understood that VMR of the polyacetylene nanofiber in high electric fields is a unique signal of the sample. Therefore, in VMR observed in high electric fields in all low conducting polyacetylene nanofiber samples, a magneto resistance difference between polyaniline and polyacetylene nanofibers according to the electric field, which are measured in the same high magnetic field system at low temperatures and high electric fields, may be a unique characteristic of the polyacetylene nanofiber. When a temperature sensor is made using such a unique characteristic, it is possible to accurately detect even when the magnetic field is changed.

In addition, zero magneto resistance of the polyacetylene nanofiber is observed both at high currents (to 100 nA shown in FIG. 1(a)) and low currents (sub nA shown in FIGS. 1(b) and 1(c)). Giant magneto resistance observed in the polyaniline nanofiber at sub nA current levels (FIGS. 3(a) and 3(b)) proves that zero magneto resistance observed in the polyacetylene nanofiber is not caused by heat that may reduce magneto resistance to zero.

The polyacetylene nanofiber described above may be applied to a high magnetic field switching device regulated by an electric field. In the high magnetic field switching device, when a current flows above a threshold value, the magnetic field decreases to “0” and the device is turned off. Using this operation, it is possible to prevent a cooling effect of the magnet due to a current overflow. Polyacetylene chains may be stabilized as a single-walled carbon nanotube inside having a diameter greater than 0.8 nm serving as conduits or gates.

As described above, according to the present invention, it is possible to accurately measure a temperature without an influence of magneto resistance even under a high magnetic field environment.

1. A polyacetylene nanofiber temperature sensor using polyacetylene nanofibers.

2. The polyacetylene nanofiber temperature sensor of claim 1, comprising
a temperature sensing unit including a polyacetylene nanofiber array in which the polyacetylene nanofibers are substantially arranged in parallel.

3. The polyacetylene nanofiber temperature sensor of claim 1, comprising
a temperature sensing unit including polyacetylene nanofiber networks, polyacetylene single fibers, or helical polyacetylene single fibers.

4. The polyacetylene nanofiber temperature sensor of claim 1,
wherein the polyacetylene nanofiber is doped with iodine.

5. A method of fabricating a temperature sensing array, comprising:
extracting polyacetylene nanofibers from a polyacetylene ribbon or sheet; and
cutting the polyacetylene nanofibers to a set length, and arranging the nanofibers substantially in parallel.
